(19) United States
(12) Patent Application Publication
(10) Pub. No.: US 2026/0264511 A1
(43) Pub. Date: Sep. 10, 2026

(54) DRIVE DEVICE, AXLE, TRANSMISSION HOUSING ASSEMBLY AND WORKING MACHINE

(71) Applicant: DEERE & COMPANY, MOLINE, IL (US)

(72) Inventor: Manuel Mann, Hüffenhardt (DE)

(21) Appl. No.: 19/447,051

(22) Filed: Jan. 13, 2026

(30) Foreign Application Priority Data
Mar. 10, 2025 (EP) 25162489.6

(51) Int. Cl. B60K 17/14

(52) U.S. Cl. CPC B60K 17/145; B60Y 2200/221

(57) ABSTRACT

A drive device includes a drive, a drive output, a first variator and a second variator, and a first transmission unit having a first input, a second input, and a first output, the first variator connected with the drive, the second variator connected with the first input and the second input, and the second variator being connectable with the drive output via the first transmission unit.

### CROSS-REFERENCE TO RELATED APPLICATIONS

This application claims priority to European Patent Application No. 25162489.6, filed Mar. 10, 2025, which is hereby incorporated by reference.

### FIELD OF THE DISCLOSURE

The disclosure relates to a drive device, an axle, a transmission housing assembly, and a working machine.

### BACKGROUND

Working machines, for example construction machines or agricultural working vehicles, particularly for example agricultural towing vehicles or tractors, are usually driven by motors. The motor can drive one or more axles or vehicle axles of the working machine here, for example a rear axle and/or a front axle. The axle(s) are usually driven by the motor's crankshaft by way of a variable-ratio gearbox and by way of one or more differential gears. The differential gear(s) can be connected on the drive output side to the vehicle axles, for example with the wheel shafts, for example of the front and/or rear wheels.

### SUMMARY

According to an aspect of the present disclosure, a drive device includes a drive, a drive output, a first variator and a second variator, and a first transmission unit having a first input, a second input, and a first output, the first variator connected with the drive, the second variator connected with the first input and the second input, and the second variator being connectable with the drive output via the first transmission unit.

According to an aspect of the present disclosure, the first transmission unit includes a first spur gear stage, a second spur gear stage, a first planetary transmission, a first shifting element, and a second shifting element.

According to an aspect of the present disclosure, the drive device includes a second transmission unit having a third spur gear stage, a fourth spur gear stage, a second planetary transmission, a fourth shifting element, and a third input having a common input with the first and second transmission units.

According to an aspect of the present disclosure, the first and second variators are configured as a hydrostat.

According to an aspect of the present disclosure, the first variator is configured as a first electric motor and the second variator is configured as a second electric motor.

According to an aspect of the present disclosure, the drive device includes a motor being connectable with the first variator via the drive.

According to an aspect of the present disclosure, the first and second transmission units include a conduit for the drive.

According to an aspect of the present disclosure, the first variator and the motor are connectable with a first power output.

According to an aspect of the present disclosure, the drive output and the first and second transmission units are connectable with a layshaft.

According to an aspect of the present disclosure, the drive device includes a control unit.

According to an aspect of the present disclosure, an axle includes the drive device in any of the preceding embodiments.

According to an aspect of the present disclosure, a transmission housing assembly includes the drive device in any of the preceding embodiments.

According to an aspect of the present disclosure, the transmission housing assembly includes a first housing module with the first transmission unit, wherein the first housing module has an input-side housing wall and an output-side housing wall, and the input-side housing wall of the first housing module has at least a first input opening, and the output-side housing wall of the first housing module has a first output opening.

According to an aspect of the present disclosure, the transmission housing assembly includes a second housing module with the second transmission unit, wherein the second housing module has an input-side housing wall and an output-side housing wall, and the input-side housing wall of the second housing module has a fourth input opening, and the output-side housing wall of the second housing module has a second output opening.

According to an aspect of the present disclosure, the transmission housing assembly has a longitudinal axis, and the first and second housing modules are arranged along the longitudinal axis of the transmission housing assembly.

According to an aspect of the present disclosure, a working machine includes the drive device in any of the preceding embodiments.

According to an aspect of the present disclosure, the drive device is arranged at least partially on two frame elements of the working machine.

The above and other features will become apparent from the following detailed description and accompanying drawings.

### BRIEF DESCRIPTION OF THE DRAWINGS

In the following, the disclosure, as well as further advantages and advantageous refinements and embodiments of the disclosure, both in terms of apparatus and process technology, are explained in more detail using example embodiments and with reference to the drawing. Components that are identical or comparable in terms of their function are designated by the same reference numerals. In the drawings:

FIG. 1 shows a schematic representation of a first example embodiment of a working machine according to the disclosure with a drive device according to the disclosure;

FIG. 2 shows a schematic representation of a first example embodiment of the drive device according to the disclosure;

FIG. 3 shows a schematic representation of a second example embodiment of the drive device according to the disclosure;

FIG. 4 shows a schematic representation of a third example embodiment of the drive device according to the disclosure;

FIG. 5 shows a schematic representation of a fourth example embodiment of the drive device according to the disclosure;

FIG. 6 shows a schematic representation of a further example embodiment of the first transmission unit;

FIG. 7 shows a schematic representation of a further example embodiment of the first transmission unit;

FIG. 8 shows a schematic representation of a further example embodiment of the second transmission unit;

FIG. 9 shows a schematic representation of a first example embodiment of a transmission housing assembly according to the disclosure;

FIG. 10 shows a schematic representation of a second example embodiment of a transmission housing assembly according to the disclosure;

FIG. 11 shows a schematic representation of a third example embodiment of a transmission housing assembly according to the disclosure;

FIG. 12 shows a schematic representation of a fourth example embodiment of a transmission housing assembly according to the disclosure;

FIG. 13 shows a schematic representation of a fifth example embodiment of a transmission housing assembly according to the disclosure;

FIG. 14 shows a schematic representation of a sixth example embodiment of a transmission housing assembly according to the disclosure;

FIG. 15 shows a schematic representation of a seventh example embodiment of a transmission housing assembly according to the disclosure;

FIG. 16 shows a schematic representation of an eighth example embodiment of a transmission housing assembly according to the disclosure; and

FIG. 17 shows a schematic representation of a further example embodiment of a working machine according to the disclosure with a transmission housing assembly and drive device according to the disclosure.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

Likewise, the working machine can additionally have a first power output, for example a mechanical power output, particularly for example a power take-off unit. The first power output can be located at a rear of the working machine, for example near an attachment interface for implements. In addition, a second power output can be located at a front of the working machine.

Based on this prior art, it is an object of the present disclosure to propose a drive device, axle, working machine and transmission housing assembly that are improved compared to the prior art. Specifically, it can be an object of the present disclosure to propose a drive device and/or an axle and/or a working machine and/or a transmission housing assembly which are configured to be structurally simpler and/or more compact and/or more modular and/or can be operated with the motor and/or in hybrid form and/or electrically and/or hydraulically and/or can be driven with the motor and/or in hybrid form and/or electrically and/or hydraulically.

This object is achieved by a drive device according to any of the embodiments disclosed herein, an axle according to any of the embodiments disclosed herein, a transmission housing assembly according to any of the embodiments disclosed herein, and a working machine according to any of the embodiments disclosed herein. One or more embodiments disclosed herein can relate to particularly advantageous embodiments of the disclosure.

According to the disclosure, a drive device for a working machine or an axle or a transmission housing assembly is proposed. The drive device comprises a drive, for example a drive shaft or input shaft, and a drive output, for example a drive output shaft or output shaft, and a first and second variator. The drive device further comprises a transmission unit with at least a first input and a second input, for example a first and second input, and at least a first output, for example a first output or a first and second output. The first variator is connected with the drive, for example the drive shaft or the input shaft. The second variator is connected with the first and second inputs. The second variator is connectable with the drive output by way of the first or through the first or with the first transmission unit.

Connected can be understood to mean for example mechanically connected and/or mechanically actively connected. Specifically, connected can additionally or alternatively be understood to mean connected in a drivable manner, that is to say connected in a torque- and/or speed-transmitting manner, and/or coupled, that is to say for example mechanically coupled, and/or rigidly coupled, and/or coupled in a rotationally fixed manner. Connectable can for example be understood to mean mechanically connectable and/or mechanically actively connectable. Specifically, connectable can additionally or alternatively be understood to mean connectable in a drivable manner, that is to say connectable in a torque- and/or speed-transmitting manner, and/or couplable, that is to say mechanically couplable and/or rigidly couplable, and/or connectable in a rotationally fixed manner. Specifically, connected can therefore be understood to mean a connection of two components which makes it possible to transmit energy and/or force and/or torque and/or speed from one component to the other, for example by mechanical means. Further components or parts can be provided between the two components which make it possible to transmit such energy and/or force and/or torque and/or speed between the two components.

A shifting element, for example a first and/or second and/or third and/or fourth and/or fifth and/or sixth and/or seventh shifting element, can be understood to mean a connecting part by means of which at least one part which transmits energy and/or force and/or torque and/or speed can be connected in a driving manner with a further part which transmits energy and/or force and/or torque and/or speed or to a part which is fixed in a location or in the housing. The respective shifting element can be shifted between at least an open and a closed state, wherein the shifting element in the open state cannot transmit energy and/or force and/or torque and/or speed between two parts interacting with the shifting element, and wherein the shifting element in the closed state can transmit energy and/or force and/or torque and/or speed between the two parts interacting with the shifting element. If there is a connection, for example an active connection, between two elements or components of the drive device, energy and/or force and/or torque and/or speed are transmitted from one element or component to the other element or component. A shifting element, for example the first and/or second and/or third and/or fourth and/or fifth and/or sixth and/or seventh shifting element, can be a clutch, for example a multi-plate clutch, and/or a brake and/or a synchronizer and/or a dog clutch.

In the following, an input, for example the first and/or second and/or third input, can be a mechanical power interface with which a force and/or a torque and/or a speed can be introduced, for example into the transmission unit, particularly for example into the first transmission unit and/or a second transmission unit. In the following, an output, for example the first and/or second and/or third output and/or the drive output and/or the layshaft, can be a mechanical power interface with which a force and/or a torque and/or a speed can be output, for example from the transmission units, particularly for example from the first transmission unit and/or the second transmission unit.

Furthermore, the first and second inputs can be connected with one another, for example configured as a common input. The first input can comprise a first drive element or be configured as a first drive element. The second input can comprise a second drive element or be configured as a second drive element. The common input can comprise a common drive element or be configured as a common drive element. The first and/or second input or the common input, for example the first and/or second drive element or the common drive element, can, for example, be configured as a shaft or a gear and/or a shifting element or comprise the latter. The first output can include a first drive output element or be configured as a first drive output element. The second output can comprise a second drive output element or be configured as a second drive output element. The first and/or second output, for example the first and/or second drive output element, can be configured as a shaft and/or a gear and/or a shifting element and/or comprise the latter.

The first and/or second input or the common input can be configured for the input-side connection and/or for connecting the first transmission unit with the second variator or a driven component of the drive device. A force and/or a torque and/or a speed can be introduced into the first transmission unit or transferred to it by way of the first and/or second input. The first and/or second output can be configured for the output-side connection, for example to the drive output. The first transmission unit can be connectable or connected with a further transmission unit and/or the drive output, for example the output shaft, with or through the first and/or second output. A force and/or a torque and/or a speed can be introduced into or transmissible to a further transmission unit and/or the drive output, for example the output shaft, by way of the first and/or second output.

The first variator can be connected with the drive directly or by way of or with or through a first transmission stage, for example a fifth spur gear stage or a first gear pair or three or more gears or a further planetary transmission, for example a third planetary transmission, or another transmission. The second variator can be connected with the first and second inputs directly or by way of or with or through a second transmission stage, for example a sixth spur gear stage or a second gear pair or three or more gears or a further planetary transmission, for example a fourth planetary transmission, or another transmission.

The drive, for example the drive shaft or input shaft, and/or the drive output, for example the drive output shaft or output shaft, can be a solid shaft. The drive and the drive output can be arranged coaxially with each other. The drive output can be connected with a propulsion drive. Specifically, the drive output can be connected with the propulsion drive with one or more or through one or more additional transmission stages. The one or more additional transmission stages can be configured as additional spur gear stages and/or additional gear pairs and/or three or more gears and/or a further planetary transmission or other transmission.

The drive device, or for example the working machine or the axle, can comprise the propulsion drive, for example a front-axle drive and/or a rear-axle drive. The drive output can be connected with a propulsion drive, for example the front-axle drive and/or the rear-axle drive. The propulsion drive can comprise a first vehicle axle or front axle and/or a second vehicle axle or rear axle and/or a first differential or a front axle differential and/or a second differential or a rear axle differential and/or the ground-engaging means. The front-axle drive can comprise the first vehicle axle or front axle and/or the first differential or the front-axle differential and/or the ground-engaging means. The rear-axle drive can comprise the second vehicle axle or rear axle and/or the second differential or the rear-axle differential and/or the ground-engaging means. The first differential can be connectable or connected on the drive side with the drive output and/or the layshaft. Furthermore, the first differential can be connectable or connected on the drive output side to the first vehicle axle, for example to a left shaft and a right shaft for driving ground-engaging means. The second differential can be connectable or connected on the drive side to the drive output and/or the layshaft. Furthermore, the second differential can be connectable or connected on the drive output side to the second vehicle axle, for example with a left shaft and a right shaft for driving ground-engaging means.

The drive device and/or the working machine and/or the axle can comprise a control unit. The control unit can be signal-connected and/or operatively coupled and/or signal-transmittingly and/or data-conductingly connected with the first and/or second variator and/or a motor. The control unit can be configured to receive one or more speed signals and/or torque signals from the drive device, for example from one or more speed and/or torque sensors of the drive device, and/or of the first and/or second variator and/or motor. The control unit can be configured to determine a speed and/or a torque with the speed signal and/or the torque signal. The control unit can be configured to set and/or adjust the speed and/or torque of the drive device, for example of the first and/or second variator, and/or motor, for example to set and/or adjust a specifiable speed and/or a specifiable torque. The control unit can be configured to set and/or adjust the speed of the first power output.

The shifting elements, for example the first and/or second and/or third and/or fourth and/or fifth and/or sixth and/or seventh shifting element, can be signal-connected and/or operatively coupled and/or signal-transmittingly and/or data-conductingly connected with the control unit. Specifically, each shifting element can comprise a valve or a valve arrangement, for example a control valve, or an actuator for controlling and/or setting and/or adjusting the respective assigned shifting element. The valve or the valve arrangement or the actuator can be connected and/or operatively coupled with the respective assigned shifting element. The control unit can be signal-connected and/or operatively coupled and/or signal-transmittingly and/or data-conductingly connected with the valve or the valve arrangement or the actuator of the respective assigned shifting element. The control unit can be configured to control and/or set and/or adjust the shifting element, for example by way of or with the respective assigned valve or the valve arrangement or the actuator. The control unit can be configured to set and/or adjust the shifting element, for example by way of or with the respective assigned valve or the valve arrangement or the actuator, into the first position, that is to say the open state, or the second position, that is to say the closed state, for example also to move it from the first into the second position and vice versa.

Specifically, the drive device can be suitable for the axle, for example an axle which is driven with the motor and/or in hybrid form and/or electrically and/or hydraulically. Furthermore, the drive device can be arranged on and/or in the axle. Specifically, the drive device can be suitable for the working machine, for example a working machine which is driven with the motor and/or in hybrid form and/or electrically and/or hydraulically. Furthermore, the drive device can be arranged on and/or in the working machine.

The drive device can comprise power electronics. The power electronics can be used to transmit power, for example electrical power, between the first and/or second variator, for example a first and/or second electric motor, and/or an energy storage unit. The drive device or the axle or the working machine can comprise the power electronics and/or the energy storage unit. The power electronics can be integrated into the control unit or controlled by the control unit as (an) external unit(s). The power electronics can comprise an electronic control unit and/or an inverter and/or a voltage transformer. During operation, the inverter and/or the voltage transformer can convert the voltage of the energy storage unit into a voltage, energy or power required by the first and/or second variator. This process can be reversed to charge the energy storage unit. The energy storage unit can be controlled by the electronic control unit to store electrical energy and/or power and/or deliver it to the first and/or second variator, for example the first and/or second electric motor. The control unit or the electronic control unit and/or the first and/or second variator, for example the first and/or second electric motor, can be electrically connected and/or electrically couplable or coupled with the power electronics and/or the energy storage unit. The power electronics, for example the electronic control unit, can be integrated into the control unit. The drive device or the axle or the working machine can comprise the energy storage unit. The first and/or second variator can be configured as a generator, and for example charge the energy storage unit in a regeneration mode. The energy storage unit can be electrically connected and/or electrically couplable to the first and/or second variator, for example the first and/or second electric motor. The energy storage unit can be an electrical energy storage unit. The energy storage unit can supply the first and/or second variator, for example the first and/or second electric motor, with energy, for example electrical energy. The energy storage unit can be connected and/or couplable, for example electrically connected and/or electrically couplable, to the first and/or second variator, for example the first and/or second electric motor. The energy storage unit can be configured as a battery and/or a rechargeable battery and/or a supercapacitor and/or a fuel cell and/or another device for storing electrical energy.

A feature of the disclosure is that the drive device can advantageously be implemented as a structurally simple drive device and also has a compact design. Furthermore, the drive device can be constructed in a modular manner, which means, for example, that the first transmission unit can be easily replaced. An advantage of this disclosure is that the same functions can be used in electrically or hydrostatically continuously variable transmissions using the same modules/transmission units from combustion engine-driven multi-step transmissions and power-branched transmissions. These modular transmission units can reduce complexity and costs. Furthermore, the electrically or hydrostatically continuously variable transmissions can be built as needed.

In an embodiment of the disclosure, the first transmission unit comprises a first spur gear stage and/or a second spur gear stage and/or a planetary transmission, for example a first planetary transmission, and at least a first and second shifting element. The first transmission unit can for example also comprise a third shifting element. Specifically, the first transmission unit can comprise, for example, the following embodiments:
the first spur gear stage and the first and second shifting elements, for example precisely only these components, or
the first and second spur gear stage and the first and second shifting elements, for example precisely only these components, or
the first spur gear stage and the planetary transmission, for example the first planetary transmission, and the first and second and third shifting element, for example precisely only these components.

In a first embodiment, the first transmission unit comprises the first spur gear stage and the first and second shifting elements, and:
the first shifting element can be connected with the second variator, and/or
the second shifting element can be connected with the second variator, and/or
the first and second shifting elements can be connected with each other, and/or
the second variator can be connectable or connected with the first spur gear stage through or by way of the first shifting element and/or the second variator can be connectable or connected with the first spur gear stage through or by way of the second shifting element, and/or
the first spur gear stage can be connected with the drive output, for example the output shaft, and/or
the first and/or second shifting element can be connectable or connected with the drive output, for example the output shaft, by way of or with the first spur gear stage.

Furthermore, the first transmission unit can have two inputs, for example the first and second input and at least one output, for example the first output or the first and second outputs. The first input can be the first shifting element or the first input, for example the first drive element, can be connected with the first shifting element. In other words, the first shifting element can be configured as the first input or can be the first input or be connected with the first input, for example the first drive element. The second input can be the second shifting element or the second input, for example the second drive element, can be connected with the second shifting element. In other words, the second shifting element can be configured as the second input or can be the second input or be connected with the second input, for example the second drive element.

The first output can be the first spur gear stage or the first output, for example the first drive output element, can be connected with the first spur gear stage. In other words, the first spur gear stage can be configured as the first output or can be the first output or be connected with the first output, for example the first drive output element. The first drive output element can be connected with the drive output.

In a second embodiment, the first transmission unit comprises the first and second spur gear stage and the first and second shifting element, and in addition or alternatively to the first embodiment:
the first shifting element can be connected with the second variator, and/or
the second shifting element can be connected with the second variator, and/or
the first and second shifting elements can be connected with each other, and/or
the second variator can be connectable or connected with the first spur gear stage through or by way of the first shifting element, and/or
the second variator can be connectable or connected with the second spur gear stage through or by way of the second shifting element, and/or
the first spur gear stage can be connected with the drive output, for example the output shaft, and/or
the second spur gear stage can be connected with the drive output, for example the output shaft, and/or
the first shifting element can be connectable or connected with the drive output, for example the output shaft, by way of or with the first spur gear stage and/or
the second shifting element can be connectable or connected with the drive output, for example the output shaft, by way of or with the second spur gear stage.

In the second embodiment, in addition to the first embodiment, the second output can be the second spur gear stage or the second output, for example the second drive output element, can be connected with the second spur gear stage. In other words, the second spur gear stage can be configured as the second output or can be the second output or can be connected with the second output, for example the second drive output element. The second drive output element can be connected with the drive output.

In a third embodiment, the first transmission unit comprises the first spur gear stage and the planetary transmission, for example the first planetary transmission, and the first and second and third shifting elements, and in addition or alternatively to the first and/or second embodiment:
the first shifting element can be connected with the second variator, and/or
the second shifting element can be connected with the second variator, and/or
the first and second shifting elements can be connected with each other, and/or
the second variator can be connected with the first planetary transmission, for example a component and/or the same component of the first planetary transmission, particularly for example the first planet carrier of the first planetary transmission, through the first shifting element and/or the second shifting element, and/or
the first planetary transmission, for example a component of the first planetary transmission, particularly for example the first planet carrier of the first planetary transmission, can be connected with the first spur gear stage, and/or
the second variator can be connected with the first planetary transmission, for example a component of the first planetary transmission, particularly for example the first sun of the first planetary transmission, and/or
the third shifting element, which can be configured for example as a brake, can be connected with the first planetary transmission, for example a component of the first planetary transmission, particularly for example the first ring gear of the first planetary transmission, and/or
the first and/or second shifting element can be connectable or connected with the drive output, for example the output shaft, by way of or with the first spur gear stage, and/or
the first planetary transmission, for example the first planet carrier, can be connectable or connected with the drive output, for example the output shaft, by way of or with the first spur gear stage.

In the third embodiment, the first transmission unit can have two inputs, for example the first and second inputs, and an output, for example the first output. The first input can be the first shifting element or the first input, for example the first drive element, can be connected with the first shifting element. In other words, the first shifting element can be configured as the first input or can be the first input or be connected with the first input, for example the first drive element. The second input can be the second shifting element and/or the first sun of the first planetary transmission or the second input, for example the second drive element, can be connected with the second shifting element and/or the first sun of the first planetary transmission. In other words, the second shifting element and/or the first sun of the first planetary transmission can be configured as the second input or can be the second input or connected with the second input, for example the second drive element.

The first output can be the first spur gear stage or the first output, for example the first drive output element, can be connected with the first spur gear stage. In other words, the first spur gear stage can be configured as the first output or can be the first output or be connected with the first output, for example the first drive output element. The first drive output element can be connected with the drive output. This advantageously allows a modular and/or compact drive device to be realized. Furthermore, the first transmission unit can advantageously be interchangeable, for example it can also be easily installed into and removed from the drive device or working machine. Furthermore, the abovementioned advantages of the drive device can be realized.

In an embodiment of the disclosure, the drive device comprises a second transmission unit. The second transmission unit comprises at least a third spur gear stage and/or a fourth spur gear stage and/or a second planetary transmission, and at least a fourth shifting element. The second transmission unit has at least a third input and at least a third output.

The first and second transmission units can have a common input. The common input can comprise the first and/or second and/or third input. The common input and/or the third input can be connected with the second variator. The second variator can be connected with the common input and/or the third input directly or by way of or with or through the second transmission stage. The third input can comprise a third drive element or be configured as a third drive element. The third input, for example the third drive element, can for example be configured as and/or comprise a shaft or a gear and/or a shifting element. The third output can comprise a third drive output element or be configured as a third drive output element. The third output, for example the third drive output element, can for example be configured as and/or comprise a shaft and/or a gear and/or a shifting element. The third input can be configured for the input-side connection and/or for connecting the second transmission unit to the second variator or a driven component of the drive device. A force and/or a torque and/or a speed can be introduced into the second transmission unit or transmitted to it by way of the third input. The third output can be configured for the output-side connection, for example to the drive output and/or the layshaft.

The second transmission unit can be connectable with a further transmission unit and/or the drive output, for example the output shaft and/or the layshaft, with or through the third output. A force and/or a torque and/or a speed can be introduced into or transmissible to a further transmission unit and/or the drive output, for example the output shaft, and/or the layshaft by way of the third output. The third output of the second transmission unit can be connectable or connected with the drive output and/or the layshaft.

Specifically, the second transmission unit can, for example, comprise the following components:
the third and fourth spur gear stages and the fourth shifting element, for example precisely only these components, or
the third and fourth spur gear stages and the second planetary transmission and the fourth shifting element, for example precisely only these components.

If the second transmission unit comprises the third and fourth spur gear stages and the fourth shifting element:
the third spur gear stage can be connected with the second variator and/or the second transmission stage, and/or
the third spur gear stage can be connected with the fourth spur gear stage, for example be in engagement with the fourth spur gear stage or be connected with it by way of a shaft, and/or
the fourth spur gear stage can be connected with the fourth shifting element, and/or
the fourth spur gear stage can be connectable with a layshaft with the fourth or through the fourth shifting element, and/or
the second variator can be connectable or connected with the fourth shifting element through or by way of the third and fourth spur gear stages and/or the second variator can be connectable or connected with the layshaft through or by way of the fourth shifting element, and/or
the layshaft can be connectable or connected with the drive output, for example the output shaft.

If the second transmission unit comprises the third and fourth spur gear stages and the second planetary transmission and the fourth shifting element:
the second planetary transmission, for example a component of the second planetary transmission, particularly for example the second ring gear of the second planetary transmission, can be connected with the second variator and/or the second transmission stage, and/or
the second transmission stage and the second ring gear can be in engagement, for example mesh with each other, or the second ring gear can be configured as a gear or component of the second transmission stage, for example the sixth spur gear stage, and/or
the second ring gear can be connected with the first and/or second shifting element, and/or
the second sun of the second planetary transmission can be connected with the drive, and/or
the second planet carrier of the second planetary transmission can be connected with the third spur gear stage, and/or
the third spur gear stage can be connected with the fourth spur gear stage, for example be in engagement with the fourth spur gear stage or be connected with it by way of a shaft, and/or
the fourth spur gear stage can be connected with the fourth shifting element, and/or
the fourth spur gear stage can be connectable with the layshaft with the fourth or through the fourth shifting element, and/or
the second variator can be connectable or connected with the layshaft through or by way of the fourth shifting element, and/or
the layshaft can be connectable or connected with the drive output, for example through or with a third transmission stage.

The third input can be the third spur gear stage or the second ring gear of the second planetary transmission or the third input, for example the third drive element, can be connected with the third spur gear stage or the second ring gear of the second planetary transmission. In other words, the third spur gear stage or the second ring gear of the second planetary transmission can be configured as the third input or can be the third input or connected with the third input, for example the third drive element. The third output can be the fourth shifting element or the third output, for example the third drive output element, can be connected with the fourth shifting element. In other words, the fourth shifting element can be configured as the third output or can be the third output or can be connected with the third output, for example the third drive output element. This advantageously allows a modular and/or compact drive device to be realized. Furthermore, the first and second transmission units can advantageously be interchangeable independently of one another, for example they can also be easily installed into and removed from the drive device or working machine. Furthermore, the abovementioned advantages of the drive device can be realized.

In an embodiment of the disclosure, the drive device comprises a motor. The motor can be connectable or connected with the drive, for example by way of or with a fifth shifting element. The motor can be connectable or connected with the first variator by way of or through the drive. The motor can be configured as an internal combustion engine. Alternatively, or additionally, the motor can be an electric motor, for example a third electric motor. The motor can be connectable or connected with the drive, for example by way of or through or with the fifth shifting element. Advantageously, the drive device, for example also the axle and/or the working machine, can thus be modularly constructed and/or driven in hybrid form.

In an embodiment of the disclosure, the first variator is configured as a first electric motor and the second variator is configured as a second electric motor. Alternatively, the first and second variators can be configured as hydrostats, wherein the hydrostat for example comprises a hydraulic pump and a hydraulic motor. The first and second variators can therefore be configured and/or operable as a hydraulic pump or hydraulic motor. Alternatively, or additionally, the first and/or second variators can be configured as a fuel cell. The first and/or second variators, for example the first and/or second electric motors, can be synchronous and/or asynchronous machines operated with direct current and/or three-phase current with permanent-magnet and/or electrical excitation, particularly for example permanent-magnet three-phase synchronous machines. The first and/or second variators can be operable as a motor and/or as a generator. The first and/or second variators can drive the drive device with a force and/or a speed and/or a torque. The first and/or second variator can each comprise a drive output shaft, for example a first and second drive output shaft. The first variator can be connectable or connected with the drive on the drive output side, that is to say for example with the first drive output shaft. The second variator can be connectable or connected with the first and/or second and/or third or the common input on the drive output side, that is to say for example with the second drive output shaft. For example, a first rotor of the first variator, for example of the first electric motor, and/or a second rotor of the second variator, for example of the second electric motor, can be connected with the respective drive output shaft. The first and/or second variator, for example the first and/or second electric motor, can be designed as a torque motor. The first and/or second variator can also be configured as a generator.

Alternatively, or additionally, the first and second variators can be configured as a hydrostat. In other words, the first and second variators can both be configured together as a hydrostat unit. The first and second variators can be configured alternately as a hydraulic pump and a hydraulic motor here. The hydrostat can have a hydraulic pump, for example an adjustable hydraulic pump, as its input element and a hydraulic motor as its output element. The hydraulic motor can be drivable by or through or with the hydraulic pump, for example through the hydraulic power supplied by the hydraulic pump. The hydraulic pump can be drivable by a power and/or speed and/or torque of the motor. The power and/or speed and/or torque of the hydraulic motor can be introduced into the first and/or second transmission unit and/or third and/or fourth transmission unit. By adjusting the hydraulic pump, the output power, that is to say for example the power and/or speed and/or torque, of the drive device, for example at the drive output, can be set. The hydraulic pump can have a pump impeller with adjustable hydraulic geometry. Alternatively, provision can be made for other means for adjusting the hydraulic pump with which the hydraulic power of the hydraulic pump can be set. This advantageously allows a hybrid drive device to be realized in a simple design.

In an embodiment of the disclosure, the first and/or the second transmission units have a conduit or a plurality of conduits, for example one or a plurality of central conduits, for the drive, for example the input shaft. The drive, for example the input shaft, can additionally be designed as a power take-off drive shaft (PTO drive shaft), for example also be able to be utilized as the latter. The drive, for example the input shaft, and the power take-off drive shaft can be configured as one shaft, for example a common shaft. The drive, for example the input shaft, can be designed as a solid shaft. The conduit or the conduits, for example the central conduits, can be configured as one or more shaft passages, for example one or more central shaft passages, for the drive, for example the input shaft. The first and/or second transmission unit can therefore have one or more shaft passages, for example one or more central shaft passages, for the drive, for example the input shaft. The first sun of the first planetary transmission and/or the second sun of the second planetary transmission and/or the first and/or second and/or third spur gear stage can each have conduits, for example shaft passages, for the drive, for example the input shaft. In this way, a direct and therefore particularly energy-efficient transmission of the torque and/or the force and/or the speed to the first power output of the drive device or working machine is possible.

In an embodiment of the disclosure, the first variator and/or the motor is connectable or connected with the first power output, for example connectable or connected with the first power output with a sixth or through a sixth shifting element. The first power output can comprise a power take-off unit or be configured as a power take-off unit. The power take-off unit can comprise a power take-off transmission and/or a power take-off shaft. The first variator and/or the motor can be connected with the sixth shifting element by way of the drive, for example the input shaft. The sixth shifting element can be connected with the first power output, for example the power take-off transmission and/or the power take-off shaft. The sixth shifting element can connect the drive, for example the input shaft, with the first power output, for example the power take-off transmission and/or the power take-off shaft. The first power output, for example the power take-off unit, particularly for example the power take-off transmission, can therefore be connectable or connected on the drive side with the drive, for example the input shaft, and/or the power-take-off drive shaft, for example by way of or through the sixth shifting element. Furthermore, the first power output, for example the power take-off unit, particularly for example the power take-off transmission, can be connectable or connected on the drive output side with the power take-off shaft. The first power output can be driven with the first variator and/or the motor. This advantageously allows a compact and/or modular and/or structurally simple embodiment of the drive device, for example of the first power output.

In an embodiment of the disclosure, the drive output and/or the first and/or second transmission unit is connectable or connected with a layshaft. The first transmission unit, for example the first and/or second output, particularly for example the first and/or second spur gear stage or the first planet carrier of the first planetary transmission, can be connectable or connected with the layshaft and/or the drive output directly or by way of or with or through a third transmission stage, for example a seventh spur gear stage or a third gear pair or three or more gears or a fifth planetary transmission or a transmission, for example by way of the drive output. Alternatively, or additionally, however, the second variator and/or the second transmission unit, for example the third and/or fourth spur gear stage can also be connectable or connected with the layshaft by way of or with or through the fourth shifting element. The layshaft can be a solid shaft. The layshaft and/or the drive, for example the input shaft, and/or the drive output, for example the output shaft can be arranged coaxially with one another. Furthermore, the layshaft can be connected with the propulsion drive, for example the front-axle drive. The layshaft can be connectable or connected with a further shaft with a fourth or by way of a fourth transmission stage, for example an eighth spur gear stage or a fourth gear pair three or more gears a sixth planetary transmission or another transmission, and/or a further shifting element. The layshaft or the further shaft can be connected with the first differential or the front axle differential. This advantageously allows for a compact and structurally simple arrangement of the drive device to be realized.

In an embodiment of the disclosure the drive device or the axle or the working machine comprises a control unit. The control unit is described in detail above and below.

The disclosure further relates to an axle, for example for a working machine, comprising a drive device, for example a drive device according to any of the embodiments disclosed here. The drive device can be arranged on the axle or integrated into the axle.

The disclosure further relates to a transmission housing assembly with a drive device, for example a drive device according to any of the embodiments disclosed herein. The transmission housing assembly comprises a first housing module with the first transmission unit, wherein the first housing module has an input-side housing wall and an output-side housing wall. The input-side and output-side housing walls of the first housing module can be any housing wall of the first housing module. The input-side housing wall of the first housing module has at least a first input opening, for example a first and second input opening. The first input opening, for example the first and second input opening, can be configured to join and/or connect the inputs of the first transmission unit, for example to join and/or connect the inputs of the first transmission unit with the second variator. The output-side housing wall of the first housing module has a first output opening. The first output opening can be configured to join and/or connect the first output of the first transmission unit with the drive output. The working machine can comprise the transmission housing assembly.

The first and second inputs or the common input can be arranged in the first input opening of the input-side housing wall of the first housing module. Specifically, the first and second inputs, for example the first and second drive elements, or the common input, for example the common drive element, can extend through the first input opening so that they are for example connectable with the second variator. However, the first input can also be arranged in the first input opening and the second input can be arranged in the second input opening. Specifically, the first input, for example the first drive element, can extend through the first input opening and the second input, for example the second drive element, can extend through the second input opening so that these are for example connectable with the second variator. The drive output, for example the output shaft, can be arranged in the first output opening of the output-side housing wall of the first housing module. Specifically, the drive output, for example the output shaft, can extend through the first output opening.

Specifically, the first transmission unit can be arranged in the first housing module. It is also possible to arrange in the first housing module the first variator and/or the first transmission stage and/or at least partially the layshaft and/or at least partially the drive output. The layshaft can be arranged in the first input opening or a third input opening of the input-side housing wall of the first housing module. Specifically, the layshaft can extend through the first or third input opening. The first housing module can have internal bearing points, for example in the form of webs or other bearing and/or fastening devices. The first transmission unit, for example components of the first transmission unit, can be mounted at and/or on and/or in the bearing points. In addition, the first variator and/or the first transmission stage and/or at least partially the layshaft and/or at least partially the drive output can be mountable at and/or on and/or in the bearing points.

The input-side or a further input-side and the output-side or a further output-side housing wall of the first housing module can have a first and second conduit opening, for example central first and second conduit openings, for the drive, for example the input shaft. However, the input-side and output-side housing wall of the first housing module can also be configured as a common housing wall of the first housing module, for example a first common housing wall. The common housing wall of the first housing module can comprise at least the first input opening, for example the first and second and/or third input opening, and the first output opening, and for example a common conduit opening. According to some embodiments, the inputs or their drive elements extend through the input openings of the first housing module and the drive output extends through the output opening. The housing arrangement can thus advantageously be easily connected and/or have a modular design.

In an embodiment of the disclosure, the transmission housing assembly comprises a second housing module with the second transmission unit, wherein the second housing module has an input-side housing wall and an output-side housing wall, and the input-side housing wall of the second housing module has at least a further, for example a fourth input opening, for joining and/or connecting the inputs of the second transmission unit, and the output-side housing wall of the second housing module has a second output opening for joining and/or connecting the second transmission unit with the drive output.

The third input or the common input can be arranged in the further input opening, for example a fourth input opening, of the input-side housing wall of the second housing module. Specifically, the third input, for example the third drive element, or the common input, for example the common drive element, can extend through the further input opening, for example the fourth input opening, so that they can be connected for example with the second variator. The layshaft can be arranged in the second output opening of the output-side housing wall of the second housing module. Specifically, the layshaft can extend through the second output opening.

Specifically, the second transmission unit can be arranged in the second housing module. The second variator and/or the second transmission stage and/or at least partially the layshaft can also be arranged in the second housing module. The layshaft can be arranged in the second output opening and/or a fifth input opening of the input-side housing wall of the second housing module. Specifically, the layshaft can extend through the second output opening and/or the fifth input opening. The second housing module can have internal bearing points, for example in the form of webs or other bearing and/or fastening devices. The second transmission unit, for example components of the second transmission unit, can be mounted at and/or on and/or in the bearing points. In addition, the second variator and/or the second transmission stage and/or at least partially the layshaft can be mounted at and/or on and/or in the bearing points. For example, the low assembly effort and high degree of compatibility and variability compared to conventional transmission housing assemblies is also particularly clear here.

The input-side or a further input-side housing wall of the second housing module can have a third conduit opening, for example a central third conduit opening, for the drive, for example the input shaft. The output-side or a further output-side housing wall of the second housing module can have a fourth conduit opening, for example a central fourth conduit opening, for the drive, for example the input shaft. However, the input-side and output-side housing wall of the second housing module can also be configured as a common housing wall of the second housing module, for example a second common housing wall. The common housing wall of the second housing module can comprise at least the fourth input opening, for example the fourth and fifth input openings, and the second output opening, and for example a further common conduit opening. This enables a direct and therefore particularly energy-efficient transmission of the torque and/or force and/or speed to a first power output of the drive device, axle or working machine.

Likewise, the input-side housing wall of the first housing module and the output-side housing wall of the second housing module can be configured as a common housing wall of the first and second housing modules. The common housing wall of the first and second housing modules can comprise the first and/or second and/or common input opening and the second output opening and/or the first conduit opening as common openings.

The first housing module can be connectable with the second housing module, for example the output-side housing wall of the second housing module and the input-side housing wall of the first housing module can be connectable or connected with each other. The first and second housing module can be connected with one another, for example fastened to one another, particularly for example releasably fastened to one another, with or through one or more fastening surfaces and housing flanges. The first housing module can comprise one or more fastening surfaces and the second housing module can comprise one or more housing flanges. Conversely, the first housing module can also comprise one or more housing flanges and the second housing module one or more fastening surfaces. Alternatively, the first and second housing modules can comprise multiple housing flanges and multiple fastening surfaces.

The input openings and/or output openings and/or conduit openings can, for example, be openings, holes or conduits for the inputs and outputs of the first and second transmission units and the drive output, and for example the drive and/or the layshaft. Specifically, the input openings and/or output openings and/or conduit openings can each be configured as shaft passages, for example central shaft passages. For example, the first and second transmission units can therefore be connectable to one another by way of the input openings and/or output openings. The input and/or output openings can also be configured as conduit openings.

Further connection options for further housing modules can be provided on the housing wall of the first and/or second housing module, for example in order to be able to connect the first and/or second differential or the first power output to the drive and/or drive output extending through the output-side housing wall of the first housing module.

The transmission housing assembly can therefore advantageously have a modular design. In this context, modular is intended to mean that the transmission housing assembly is composed of several housing modules, and for each of the transmission units described above, a housing module is configured which forms the entire transmission housing assembly when combined with the other housing modules. The adjacent and/or contiguous housing walls can be configured as common housing walls here. Such an arrangement makes it easy and cost-effective to replace the first and/or second transmission unit without having to completely dismantle the entire drive device. This clearly shows the advantages of a transmission assembly in terms of reduced assembly effort, high degree of compatibility and variability. Furthermore, the drive device can advantageously be arranged modularly and/or constructed modularly through the transmission housing assembly.

In an embodiment of the disclosure, the first and second housing modules are arranged along a longitudinal axis of the transmission housing assembly, and for example a longitudinal axis of the working machine. The longitudinal axis of the transmission housing assembly and the longitudinal axis of the working machine can be identical or parallel.

The disclosure further relates to a working machine with an axle, for example an axle according to any of the embodiments disclosed herein, or a drive device, for example a drive device according to any of the embodiments disclosed herein, or a transmission housing assembly, for example a transmission housing assembly according to any of the embodiments disclosed herein. The working machine can be a construction machine or a towing vehicle, for example an agricultural towing vehicle, for example a tractor. The working machine has the advantages of the drive device and/or transmission housing assembly described above.

The working machine comprises the drive device and/or the axle and/or the transmission housing assembly. The drive device is configured to drive the working machine. The working machine can comprise one, two or more axles. Specifically, the drive device can be integrated on or into the axle, for example into the first and/or second vehicle axle. The working machine can be drivable with a speed and/or force and/or torque of the first and/or second variator and/or motor.

The control unit can be set up to control and/or regulate, for example to set and/or adjust, the working machine, for example the motor and/or the first and/or second variator. The working machine can comprise an input and output unit. The control unit can be signal-connected and/or operatively coupled and/or signal-transmittingly and/or data-conductingly connected with the input and output unit, and/or be controllable and/or settable and/or adjustable with the input and output unit. The input and output unit can be integrated into the control unit or vice versa. The operator of the working machine can, for example, set and/or adjust the speed of the working machine with or through the input and output unit.

The working machine can also comprise one or more auxiliary units, for example a pump and/or a cooler, etc. The auxiliary units can be part of the hydraulics of the drive device. Instead of the drive device, the working machine can comprise the first power output, for example the power take-off unit. The control unit can be configured to set and/or adjust and/or actuate the drive device and/or the axle and/or working machine with a drive signal and, with or based on the drive signal, to set and/or adjust, for example to increase or decrease, the speed of the working machine. The working machine can comprise the ground-engaging means. The ground-engaging means can support and/or carry the working machine on the ground. A towing vehicle frame of the working machine, for example a first and second frame element, can be supported on the ground-engaging means. The ground-engaging means can be wheels or tracks or chains. The ground-engaging means can for example be front wheels and rear wheels. The working machine can comprise a speed sensor, for example a rotational speed sensor, for detecting a speed of the working machine. Specifically, the control unit can be configured to set and/or adjust and/or actuate a force and/or a torque and/or a speed of the motor and/or of the first and/or second variator with the driving signal.

In an embodiment of the disclosure the working machine comprises two frame elements, for example a first and a second frame element. The drive device, for example the transmission housing assembly, particularly for example the first and/or second housing module, is arranged on, for example between, the frame elements. The frame elements, for example the first and second frame elements, can be arranged parallel to the longitudinal axis of the working machine. The transmission housing assembly, for example the first and second housing modules, can be arranged along the longitudinal axis of the working machine. The longitudinal axis of the transmission housing assembly and the longitudinal axis of the working machine can be identical or parallel. The first and/or second housing module can be arranged between the frame elements, for example also be fastened and/or mounted on them. Likewise, the power take-off unit can be arranged on the frame elements, for example be fastened and/or mounted on them.

The shifting elements, for example their valves or valve devices or actuators, and/or the energy storage unit and/or the power electronics and/or the first and/or second variator and/or the motor and/or the first power output, for example the power take-off unit, can be actuated and/or set and/or adjusted, for example controlled and/or regulated by the control unit. The control unit can send and/or receive signals for controlling the operation of the drive device and/or the axle and/or the working machine. Expediently, the signals can be provided by way of a suitable data communication network, for example one which complies with the ISOBUS and/or CAN standard. The control unit can be configured as an electronic module, an embedded system, a computing unit, a computer, or as a module for controlling and/or regulating the drive device and/or the axle and/or the working machine. The control unit can comprise one or more processors, a memory and/or all software, hardware, algorithms, connections, and for example sensors, which are required for controlling and/or regulating the drive device and/or the axle and/or the working machine. Methods can be configured as a program or algorithm which can be executed on and/or with the control unit. The control unit can comprise any device which analyses data from various sensors, compares data and makes the necessary decisions in order to control and/or regulate and/or execute the operation of the drive device and/or the axle and/or the working machine and the necessary tasks to control and/or regulate the operation of the drive device and/or the axle and/or the working machine. The control unit can be signal-connected and/or operatively coupled and/or signal-transmittingly and/or data-conductingly connected with the components of the drive device and/or the axle and/or the working machine, that is to say for example the first power output and/or the shifting elements, for example the valves or valve devices or actuators of the shifting elements and/or the energy storage unit and/or the power electronics and/or the first and/or second variator and/or the motor and/or the sensors, for example the speed sensor and/or the speed and/or torque sensor(s). A signal-connected and/or operatively coupled and/or signal-transmitting and/or data-conducting connection can be understood here, inter alia, as an exchange of signals or data between the connected components and the control unit. Signals can, for example, be received and sent by the control unit and/or processed and/or manipulated. The connection between the control unit and the parts or components of the drive device and/or the axle and/or the working machine can be wired, that is to say for example with a cable, and/or wireless, that is to say by radio, for example with Bluetooth or WLAN. Communication can take place, for example, via ISOBUS, CAN bus or the like. The control unit can be connected directly to the input and output unit, for example to the input and output unit which is arranged in a cab of the working machine and by means of which data entered by an operator can be transmitted to the control unit or can be received from the latter and output. The control unit can be integrated into the input and output unit, or vice versa.

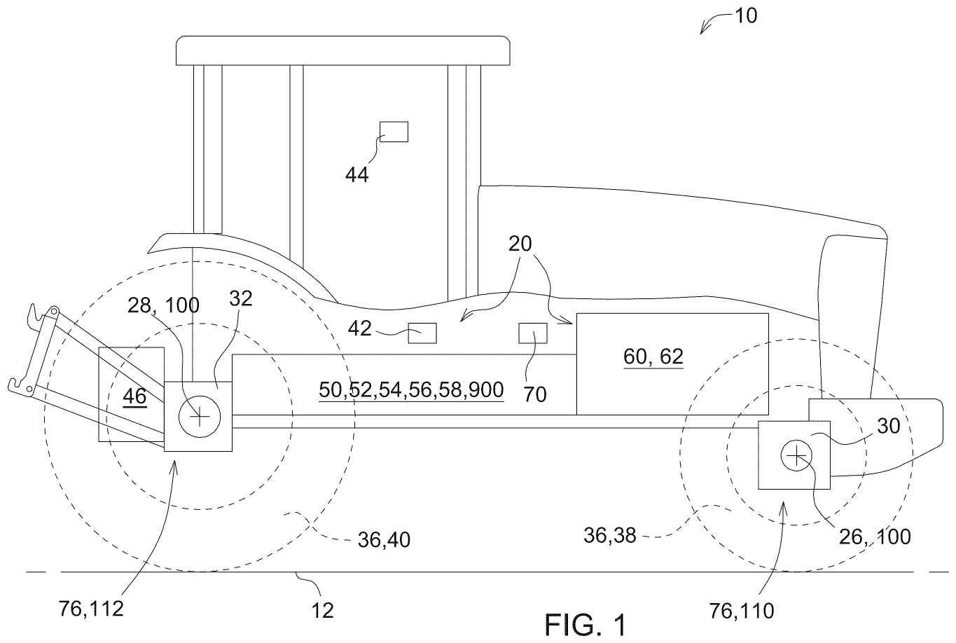

FIG. 1 shows a schematic representation of a first example embodiment of a working machine 10 according to the disclosure, here an agricultural towing vehicle or tractor, with a drive device 20 according to the disclosure. The working machine 10 can be driven by the drive device 20.

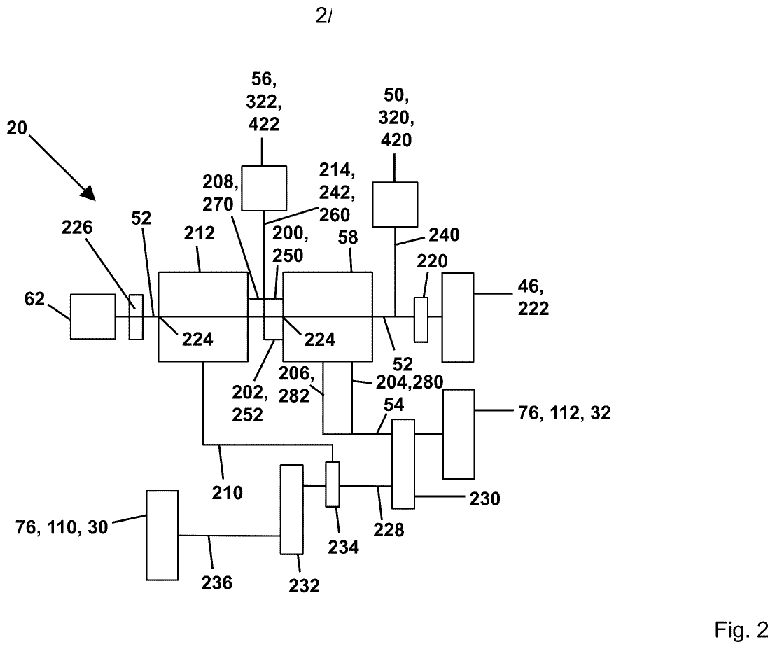

The drive device 20 comprises a drive 52, which can be configured for example as a drive shaft or input shaft, and a drive output 54, which can be configured for example as a drive output shaft or output shaft, and a first and second variator 50, 56, and a first transmission unit 58. The first transmission unit 58 has a first and second input 200, 202 (see FIGS. 2 to 8) and at least a first output 204 (see FIGS. 2 to 8). The first transmission unit 58 can additionally have a second output 206 (see FIGS. 2 to 8). The second variator 56 is connectable or connected with the drive output 54 by way of the first transmission unit 58. Furthermore, the first variator 50 is connected with the drive 52. The second variator 56 is connected with the first input 200 and the second input 202.

The working machine 10, for example the drive device 20, comprises a first vehicle axle 26 and a second vehicle axle 28. The first vehicle axle 26 can be a front axle and the second vehicle axle 28 a rear axle. Furthermore, the first vehicle axle 26 can be designed as a steerable axle. The working machine 10 can have one or more ground-engaging means 36, shown here in the form of wheels 38, 40, which engage with a ground 12 for transmitting driving forces and/or through which the working machine 10 is supported on the ground 12. The working machine 10, for example the drive device 20, can comprise a propulsion drive 76, for example a front-axle drive 110 and a rear-axle drive 112. The propulsion drive 76 can comprise the first vehicle axle 26 and/or the second vehicle axle 28 and/or a first differential 30 and/or a second differential 32 and/or the ground-engaging means 36. The working machine 10, for example the drive device 20, can have a front-axle drive 110, which can comprise the first vehicle axle 26 and/or the first differential 30, that is to say for example a front-axle differential, and/or the ground-engaging means 36. The working machine 10, or for example the drive device 20, can likewise have a rear-axle drive 112, which can comprise the second vehicle axle 28 and/or the second differential 32, that is to say for example a rear axle differential, and/or the ground-engaging means 36. The first vehicle axle 26 can be connected with the first differential 30. The second vehicle axle 28 can be connected with the second differential 32.

The drive output 54 can be connected with the propulsion drive 76, for example the first and/or second differential 30, 32, for example only with the second differential 32. The drive output 54 can be connected with the second vehicle axle by way of the second or with the second differential 32. A force and/or a torque and/or a speed can be transmitted by way of the first or with the first differential 30 and/or the second or with the second differential 32 from the drive output 54 to the first and/or second vehicle axle 26, 28, and therefore for example to the ground-engaging means 36.

The first and/or second variator 50, 56 can for example be designed as a first and second electric motor. Alternatively, or additionally, the first and second variators 50, 56 can be designed as a hydrostat. The drive device or the working machine can comprise a motor 62. The motor can be connectable or connected with the drive 52. The motor 62 can likewise be connectable or connected with the first variator 50 by way of or through the drive 52.

With the drive device 20, for example the motor 62 and/or the first and/or second variator 50, 56, a rotational movement and/or force and/or a torque and/or a speed can be generated and, for example by way of the first and/or a second transmission unit 58, 212, can be transmitted to the drive output 54 or to the first and/or second vehicle axle 26, 28. The first and/or second vehicle axles 26, 28 convert the rotational movement and/or force and/or the torque and/or the speed into a rotational movement and/or force and/or a torque and/or speed of one or more ground-engaging means 36 and therefore into a thrust of the working machine 10. The working machine 10 can also have a towing vehicle frame, for example a first and second frame element 960, 962, 964 (see FIG. 17), which can be carried for example by the ground-engaging means 36, for example the wheels 38, 40, suspended from the first and/or second vehicle axle 28, 30. Specifically, a first pair of wheels 38 are arranged on the first vehicle axle 26 and a second pair of wheels 40 are arranged on the second vehicle axle 28. Here, the diameters of the wheels 38, 40 can differ from one another; for example, the diameter of the first pair of wheels 38 can be smaller than the diameter of the second pair of wheels 40. Alternatively, the ground-engaging means 36 can also be configured and arranged as tracks or chains.

Furthermore, the working machine 10 can alternatively or additionally comprise the drive device 20 or an axle 100, or power electronics 70 in order to transmit the electrical power or energy between the first and second variators 50, 56, for example the first and second electric motors, and an energy storage unit 60. In the embodiment shown, the working machine 10 can be driven by the motor 62 and/or in hybrid form and/or electrically and/or hydraulically. The working machine 10, for example the drive device 20, can comprise a first power output 46. The first power output can comprise a power take-off unit 222. The first power output 46 can be provided for driving an implement (not shown) which can be attached to the working machine 10 by way of an interface (e.g. a three-point interface). Specifically, an axle 100 can comprise the drive device 20 or the drive device 20 can be arranged on or in the latter, for example on the first and/or second vehicle axle 26, 28. The energy storage unit 60 can supply the electrically driven components of the drive device 20, for example the first and/or second variator 50, 56, particularly for example the first and/or second electric motor, with currents or voltages of suitable frequency and amplitude in order to provide predeterminable speeds and/or torques for the drive device 20.

The working machine 10, for example alternatively or additionally the axle 100 or the drive device 20, can comprise a control unit 42 and/or an input and output unit 44. The control unit 42 can be signal-connected and/or operatively coupled and/or signal-transmittingly and/or data-conductingly connected with the input and output unit 44. Specifically, the control unit 42 can be directly connected with the input and output unit 44 arranged in a cabin of the working machine 10, through which data entered by an operator can be transmitted to the control unit 42 or received by the latter and output. The drive device 20, and/or for example the working machine 10 or the axle 100, can be settable and/or adjustable with the control unit 42. The control unit 42 is signal-connected and/or operatively coupled and/or signal-transmittingly and/or data-conductingly connected with the motor 62 and/or the first and second variators 50, 56. The control unit 42 is configured to set and/or adjust the speed and/or torque and/or power of the drive device 20, for example the motor 62 and/or the first and/or second variator 50, 56, for example to actuate and/or control and/or regulate the latter.

The control unit 42 can be configured to set and/or adjust a predeterminable speed and/or a predeterminable torque and/or a predeterminable power of the drive device 20, for example the motor 62 and/or the first and second variator 50, 56, for example to actuate and/or control and/or regulate the latter. The control unit 42 can be signal-connected and/or operatively coupled and/or signal-transmittingly and/or data-conductingly connected with the energy storage unit 60 and/or power electronics 70 and/or sensors of the drive device 20. The control unit 42 can be configured to set and/or adjust the drive device 20, for example alternatively or additionally the axle 100 or the working machine 10, in order to set and/or adjust, for example to control and/or regulate, the speed and/or torque and/or power of the motor 62 and/or the first and/or second variator 50, 56.

FIG. 2 shows a schematic representation of a first example embodiment of the drive device 20 according to the disclosure. The drive device 20 shown in FIG. 2 corresponds substantially to the drive device 20 in FIG. 1, so only details and/or differences will be discussed below. The working machine 10 shown in FIG. 1 can comprise the drive device 20 shown in FIG. 2.

The drive device 20 according to FIG. 2 comprises the drive 52 and the drive output 54 and the first and second variators 50, 56 and/or the motor 62. Furthermore, the drive device 20 comprises the first transmission unit 58, wherein the first transmission unit 58 has the first and second inputs 200, 202, for example a first and second drive element 250, 252, and a first output 204, and for example can additionally have a second output 206. The second variator 56 is connectable or connected with the drive output 54 by way of or through the first transmission unit 58, and for example optionally additionally by way of or through a second transmission unit 212. Furthermore, the second variator 56 is connectable or connected with the first and second inputs 200, 202, for example the first and second drive elements 250, 252.

The first transmission unit 58 can comprise a first spur gear stage and/or a second spur gear stage and/or a planetary transmission, for example a first planetary transmission, and at least a first and second shifting element. The first transmission unit 58 can additionally comprise a third shifting element 702 (see FIG. 7).

The first variator 50 can be configured as a first electric motor 420 and the second variator 56 can be configured as a second electric motor. Alternatively, the first and second variators 50, 56 can be configured as hydrostats, wherein for example the first variator 50 can be a hydraulic pump and the second variator 56 can be a hydraulic motor. The second variator 56 can drive the drive device 20 with a force and/or a speed and/or a torque. The first variator 50 is connected with the drive 52 on the drive side. The first variator 50 is connected with the drive 52 by way of or with or through a first transmission stage 240. The second variator 56 is connected with the first and second inputs 200, 202, for example the first and/or second drive element 250, 252, by way of or with or through a second transmission stage 242. The motor 62 can be connectable or connected with the drive 52, for example by way of or with a fifth shifting element 226.

The drive device 20 can also comprise the second transmission unit 212, which comprises at least a third spur gear stage 500 and/or a fourth spur gear stage 502 and/or a second planetary transmission, and at least a fourth shifting element 234. The second transmission unit has at least a third input 208, for example with a third drive element, and at least a third output 210, for example with at least a third drive output element. The first and second transmission unit 58, 212 can have a common input 214, for example with a common drive element 260. The common input 214 can for example comprise the first and second and/or third inputs 200, 202, 208. The second variator 56 can be connected with the third input 208 and/or for example with the common input 214. As a result, a force and/or a torque and/or a speed can be transmitted from the second variator 56 to the first and/or second transmission unit 58, 212. The second transmission unit 212 can be arranged in front of the first transmission unit 58 in the torque and/or power flow.

The drive device 20 can also comprise the first power output 46. The motor 62 and/or the first variator 50 can be connectable or connected with the first power output 46, for example can be connectable or connected with the first power output 46 with a sixth or through a sixth shifting element 220. Specifically, the motor 62 and/or the first variator 50 can be connectable or connected with the first power output 46 through or by way of the drive 52, for example can be connectable or connected with the first power output 46 with the sixth or through the sixth shifting element 220. The first power output 46 can comprise a power take-off unit 222. The power take-off unit 222 can comprise a power take-off transmission and/or a power take-off shaft. The fifth shifting element 220 and/or the power take-off unit 222, for example the power take-off transmission, can be connected with the drive 52 on the drive side. Furthermore, the power take-off unit 222, for example the power take-off transmission, can be connectable or connected with the power take-off shaft on the drive output side. The first and/or second transmission unit 58, 212 can also have a conduit 224, for example a central conduit, for the drive 52, that is to say for example the drive shaft or input shaft.

The drive output 54 and/or the first transmission unit 58 can be connectable or connected with a layshaft 228. The first transmission unit, for example the first and/or second output, particularly for example the first and/or second spur gear stage or the first planet carrier of the first planetary transmission, can be connectable or connected with the drive output 54 and/or, for example by way of the drive output 54, with the layshaft 228 directly or by way of or with or through a third transmission stage 230, for example a seventh spur gear stage or a third gear pair or three or more gears or a fifth planetary transmission or a transmission. Alternatively, or additionally, however, the second variator 56 and/or the second transmission unit 212, for example the third and/or fourth spur gear stage can also be connectable or connected with the layshaft 228 and/or the drive output 54 by way of or with or through the fourth shifting element 234. The layshaft 228 and/or the drive output 54, for example the output shaft, can be a solid shaft. The layshaft 228 and/or the drive output 54, for example the output shaft, can be arranged coaxially with one another. Furthermore, the layshaft 228 can be connected with the propulsion drive 76, for example the front-axle drive 110, particularly for example the first differential 30. The layshaft 228 can be connectable or connected with a further shaft 236 with a fourth or by way of a fourth transmission stage 232, for example a sixth spur gear stage or a gear pair or three or more gears or a sixth planetary transmission or another transmission, and/or a further shifting element. The layshaft 228 or the further shaft 236 can be connected with the first differential 30 or the front-axle differential. The drive output 54 can also be connected with the propulsion drive 76, for example the rear-axle drive 112, particularly for example the second differential 32.

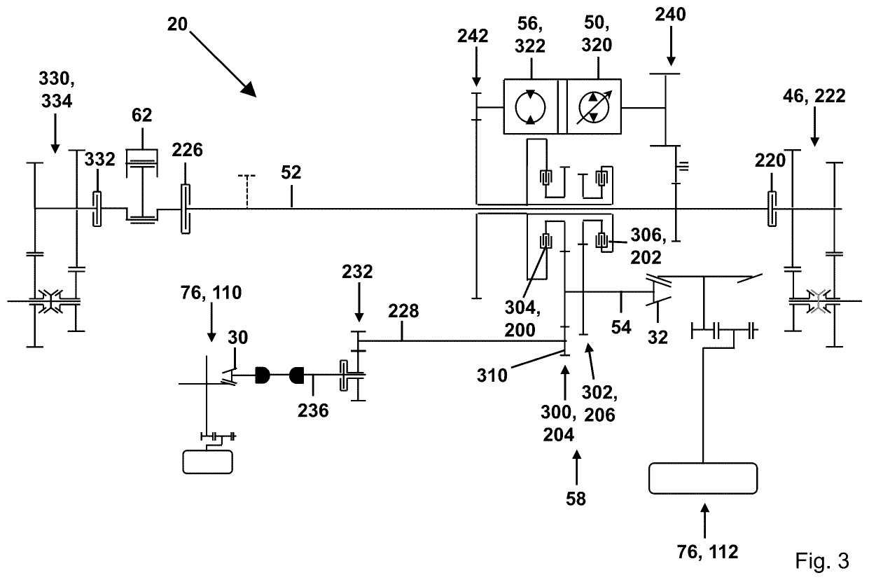

FIG. 3 shows a schematic representation of the second example embodiment of the drive device 20 according to the disclosure. The drive device 20 shown in FIG. 3 corresponds substantially to the drive device 20 shown in FIGS. 1 and 2, so only details and/or differences will be discussed below. The working machine 10 shown in FIG. 1 can comprise the drive device 20 shown in FIG. 3.

The first and second variators 50, 56 are configured here as hydrostats, for example the first variator 50 as a hydraulic pump 320 and the second variator 56 as a hydraulic motor 322. The first variator 50 is connected with the drive 52 by way of the first transmission stage 240, in the present case a fifth spur gear stage or three gears which are in engagement with one another. The second variator 56 is connected with the first and second inputs 200, 202 by way of the second transmission stage 242, in the present case a sixth spur gear stage. The motor 62 is connectable or connected with the drive 52, for example by way of the fifth or with the fifth shifting element 226.

The first transmission unit 58 comprises a first spur gear stage 300 and a second spur gear stage 302 and a first and second shifting element 304, 306. The first shifting element 304 is configured as the first input 200 and/or is the first input 200. Alternatively, or additionally, the first shifting element 304 can be connected with the first input 200, for example the first drive element 250, and/or with the common input 214, for example the common drive element 260. The second shifting element 306 is configured as the second input 202 and/or is the second input 202. Alternatively, or additionally, the second shifting element 306 can be connected with the second input 202, for example the second drive element 252, and/or with the common input 214, for example the common drive element 260. The first spur gear stage 300 is configured as the first output 204 and/or is the first output 204. Alternatively, or additionally, the first spur gear stage 300 can be connected with the first output 204, for example the first drive output element 280. The first spur gear stage 300 is connected with the drive output 54. In addition, the first spur gear stage 300 is connected with the layshaft 228 by way of a coupling gear 310 meshing with the first spur gear stage. The second spur gear stage 302 is configured as the second output 206 and/or is the second output 206. Alternatively, or additionally, the second spur gear stage 302 can be connected with the second output 206, for example the second drive output element 282. The second spur gear stage 302 is also connected with the drive output 54.

The layshaft 228 is connected with the first differential 30. The layshaft 228 is connectable or connected with a further shaft 236 by way of the fourth transmission stage 232, in the present case a sixth spur gear stage, and a further shifting element. The further shaft 236 can be connected with the first differential 30. The drive output 54 is connected with the second differential 32.

The drive device 20 can also comprise a second power output 330. The motor 62 can be connectable or connected with the second power output 330, for example can be connectable or connected with the second power output 330 with a seventh or through a seventh shifting element 332. The second power output 330 can comprise a further power take-off unit 334. The further power take-off unit 334 can comprise a further power take-off transmission and/or a further power take-off shaft. The seventh shifting element 330 and/or the further power take-off unit 334, for example the power take-off transmission, can be connected with the motor 62 on the drive side. Furthermore, the further power take-off unit 334, for example the power take-off transmission, can be connectable or connected with the power take-off shaft on the drive output side.

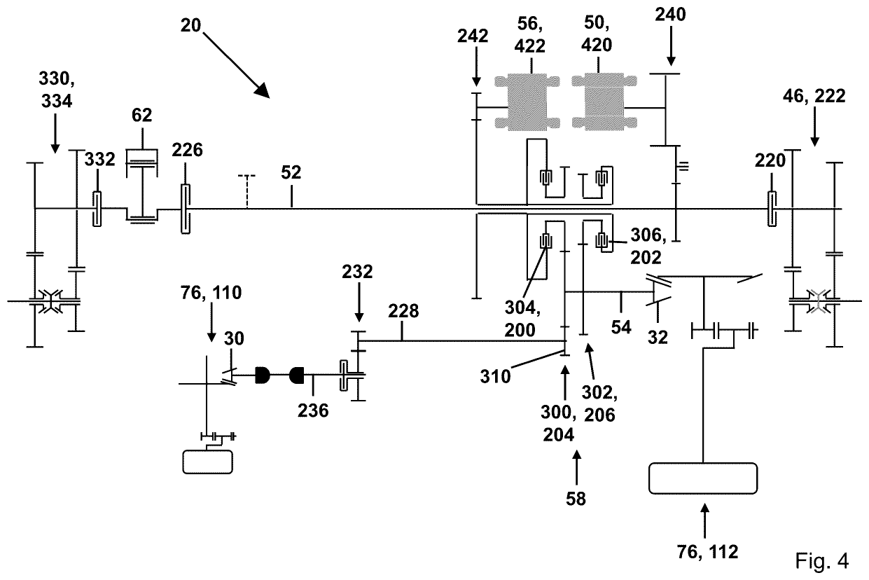

FIG. 4 shows a schematic representation of the third example embodiment of the drive device 20 according to the disclosure. The drive device 20 shown in FIG. 4 corresponds substantially to the drive device 20 shown in FIGS. 1 to 3, so only details and/or differences will be discussed below. The working machine 10 shown in FIG. 1 can comprise the drive device 20 shown in FIG. 4. FIG. 4 shows the drive device 20, wherein the first variator 50 is configured as the first electric motor 420 and the second variator 56 as the second electric motor 422.

With the third embodiment according to FIG. 4, two modes for each direction of rotation of the drive output 54 of the drive device 20, or in other words in the forwards and reverse directions of the drive device 20 or working machine 10, can be realized with the first and/or second transmission unit 58, 212 (see Table 1). Specifically, two forwards and two reverse gears of the drive device 20 or working machine 10 can be realized.

TABLE 1
Modes of the third embodiment.

| Forward Mode | Reverse Mode | 304 | 306 |
|---|---|---|---|
| Mode 1 | | X | |
| Mode 2 | | | X |
| | Mode 1 | X | |
| | Mode 2 | | X |

The modes can be realized by opening and closing the shifting elements and/or coupling elements associated with the reference signs mentioned, as shown in Table 1. Specifically, the modes can be realized by opening and closing the first shifting element 304 and/or the second shifting element 306 as shown in Table 1.

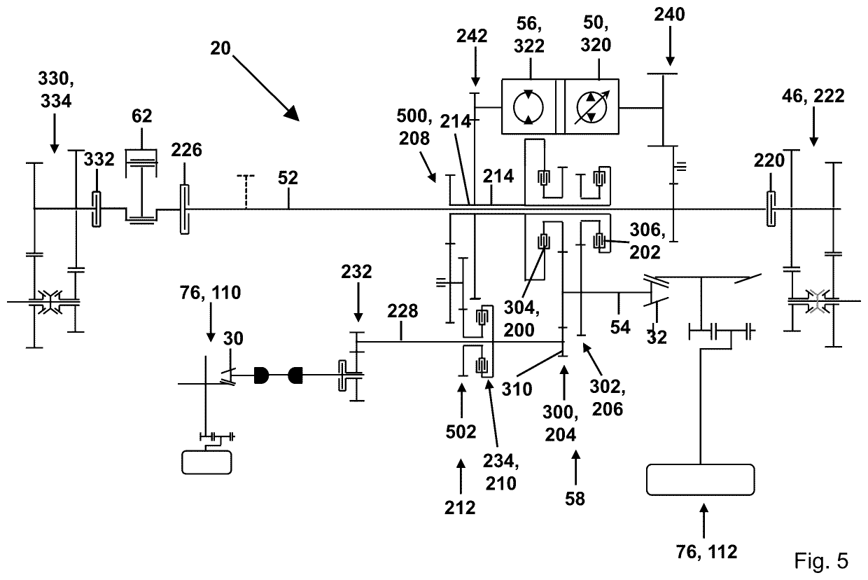

FIG. 5 shows a schematic representation of the fourth example embodiment of the drive device 20 according to the disclosure. The drive device 20 shown in FIG. 5 corresponds substantially to the drive device 20 shown in FIGS. 1 to 4, so only details and/or differences will be discussed below. The working machine 10 shown in FIG. 1 can comprise the drive device 20 shown in FIG. 5. The second transmission unit 212 comprises the third spur gear stage 500 and the fourth spur gear stage 502 and the fourth shifting element 234.

The second transmission unit 212 has the third input 208 and the third output 210. The first and second transmission units 58, 212 are optionally or alternatively connected with the second variator 56 through or by way of or with the common input 214. As a result, a force and/or a torque and/or a speed can be transmitted from the second variator 56 to the first and second transmission units 58, 212. The third spur gear stage 500 is configured as the third input 208 and/or is the third input 208. Alternatively, or additionally, the third shifting element 500 can be connected with the third input 208, for example the third drive element 270, and/or with the common input 214, for example the common drive element 260. The fourth spur gear stage 502 is in engagement with the third spur gear stage 500, for example meshes with the third spur gear stage 500. Furthermore, the fourth spur gear stage 502 is connected with the fourth shifting element 234. The fourth shifting element 234 is configured as the third output 210 and/or is the third output 210. Alternatively, or additionally, the fourth shifting element 234 can be connected with the third output 210. The fourth shifting element 234 is connectable or connected with the layshaft 228. The second transmission unit 212, for example the fourth spur gear stage 502, is connectable or connected with the layshaft 228 by way of or through or with the fourth shifting element 234.

With the eighth embodiment, the first, second, third and fourth transmission units can each realize four modes per direction of rotation of the drive output of the drive device, or in other words in four forwards and four reverse gears of the drive device or working machine (see Table 2).

With the fourth embodiment according to FIG. 5, three modes for each direction of rotation of the drive output 54 of the drive device 20 or working machine 10, or in other words in the forwards and reverse directions of the drive device 20 or working machine 10, can be realized with the first and second transmission units 58, 212 (see Table 2). Specifically, three forwards and three reverse gears of the drive device 20 or working machine 10 can be realized.

TABLE 2
Modes of the fourth embodiment.

| Forward | Reverse | | | |
|---|---|---|---|---|
| [symbol] | [symbol] | 304 | 306 | 234 |
| [symbol] | | | | [symbol] |
| [symbol] | | [symbol] | | |
| [symbol] | | | [symbol] | |
| | [symbol] | | | [symbol] |
| | [symbol] | [symbol] | | |
| | [symbol] | | [symbol] | |

[symbol]

indicates data missing or illegible when filed

The modes can be realized by opening and closing the shifting elements and/or coupling elements associated with the reference signs mentioned, as shown in Table 2. Specifically, the modes can be realized by opening and closing the first shifting element 304 and/or the second shifting element 306 and/or the fourth shifting element 234 as shown in Table 2.

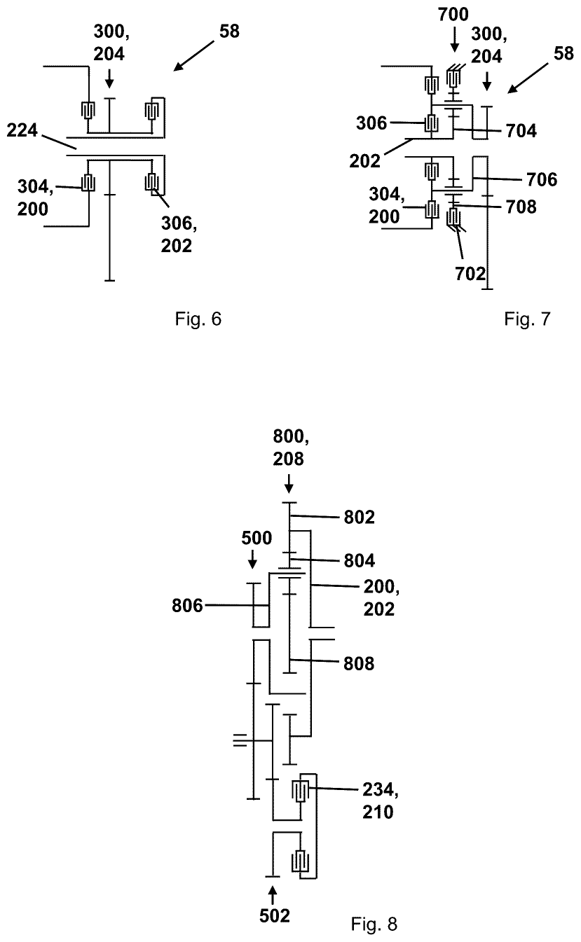

FIG. 6 shows a schematic representation of a further example embodiment of the first transmission unit 58, for example an alternative example embodiment of the first transmission unit 58 to FIGS. 2 to 5. The first transmission unit 58 shown in FIG. 6 corresponds substantially to the first transmission unit 58 of the drive device 20 according to the disclosure shown in FIGS. 1 to 5, so only details and/or differences will be discussed below. The drive device 20 or axle 100 or working machine 10 shown in FIGS. 1 to 5 can comprise the first transmission unit 58 shown in FIG. 6.

In the example embodiment according to FIG. 6 the first transmission unit 58 comprises the first spur gear stage 300 and the first and second shifting elements 304, 306. The first shifting element 304 is configured as the first input 200 and/or is the first input 200. Alternatively, or additionally, the first shifting element 304 can be connected with the first input 200, for example the first drive element 250. The second shifting element 306 is configured as the second input 202 and/or is the second input 202. Alternatively, or additionally, the second shifting element 306 can be connected with the second input 202, for example the second drive element 252. The first spur gear stage 300 is configured as the first output 204 and/or is the first output 204. Alternatively, or additionally, the first spur gear stage 300 can be connected with the first output 204, for example the first drive output element 280. The first spur gear stage 300 is connected with the drive output 54 (see also FIGS. 3 to 5). The second variator 56 is connectable with the first spur gear stage 300 through or by way of the first shifting element 304 and connectable with the first spur gear stage 300 through or by way of the second shifting element 306. Furthermore, the first and/or second shifting elements 304, 306 are connectable or connected with the drive output 54 by way of or with the first spur gear stage 300. The first transmission unit 58 therefore has the first and second input 200, 202 and the first output 204.

FIG. 7 shows a schematic representation of a further example embodiment of the first transmission unit 58, for example an alternative example embodiment of the first transmission unit 58 to FIGS. 2 to 6. The first transmission unit 58 shown in FIG. 7 corresponds substantially to the first transmission unit 58 of the drive device 20 according to the disclosure shown in FIGS. 1 to 6, so only details and/or differences will be discussed below. The drive device 20 or axle 100 or working machine 10 shown in FIGS. 1 to 6 can comprise the first transmission unit 58 shown in FIG. 7.

The first transmission unit 58 comprises the first spur gear stage 300 and the first planetary transmission 700. Furthermore, the first transmission unit 58 comprises the first and the second and the third shifting elements 304, 306, 702. The first shifting element 304 is configured as the first input 200 and/or is the first input 200. Alternatively, or additionally, the first shifting element 304 can be connected with the first input 200, for example the first drive element 250. The second shifting element 306 and the first sun 704 of the first planetary transmission 700 are connected with the second input 202, for example the second drive element 252. Alternatively, the second shifting element 306 and/or the first sun 704 of the first planetary transmission 700 can be configured as the second input 202 and/or be the second input 202. In other words, the second input 202, for example the second drive element 252, of the first transmission unit 58 is connected with the second shifting element 306 and the first sun 704 of the first planetary transmission 700.

The second variator 56 is connectable or connected with the first planet carrier 706 of the first planetary transmission 700 by way of the first and/or second or with the first and/or second shifting element 304, 306. The first spur gear stage 300 is configured as the first output 204 and/or is the first output 204. Alternatively, or additionally, the first spur gear stage 300 can be connected with the first output 204, for example the first drive output element 280. The first spur gear stage 300 can be connected with the drive output 54. The first planetary transmission 700, for example the first planet carrier 706 of the first planetary transmission 700, is connected with the first spur gear stage 300. The first and/or second shifting element 304, 306 is connectable or connected with the drive output 54, for example the output shaft, by way of or with the first spur gear stage 300. Similarly, the first planetary transmission 700, for example the first planet carrier 706, is connected with the drive output 54 by way of or with the first spur gear stage 300. The third shifting element 702, which is configured by way of example as a brake here, is connectable or connected with the first planetary transmission 700, for example a component of the first planetary transmission 700, particularly for example the first ring gear 708 of the first planetary transmission 700.

FIG. 8 shows a schematic representation of a further example embodiment of the second transmission unit 212, for example an alternative example embodiment of the second transmission unit 212 to FIGS. 2 to 5. The second transmission unit 212 shown in FIG. 8 corresponds substantially to the second transmission unit 212 of the drive device 20 according to the disclosure shown in FIGS. 1 to 5, so only details and/or differences will be discussed below. The drive device 20 or axle 100 or working machine 10 shown in FIGS. 1 to 5 can comprise the second transmission unit 212 shown in FIG. 8.

The second transmission unit 212 comprises the second planetary transmission 800 and the third spur gear stage 500 and the fourth spur gear stage 502 and the fourth shifting element 234. The second transmission unit 212 has the third input 208 and the third output 210. The second planetary transmission 800, for example a component of the second planetary transmission 800, particularly for example the second ring gear 802 of the second planetary transmission 800, is configured as the third input 208 and/or is the third input 208.

Alternatively, or additionally, the second planetary transmissions 800, for example a component of the second planetary transmission 800, particularly for example the second ring gear 802 of the second planetary transmission 800, can be connected with the third input 208. The second planetary transmission 800, for example a component of the second planetary transmission 800, particularly for example the second ring gear 802 of the second planetary transmission 800, can be connectable or connected with the first and/or second input 200, 202 of the first transmission unit 58. Alternatively, the first and second transmission units 58, 212 can therefore be connectable or connected with the second variator 56 through or by way of or with the common input 214. As a result, a force and/or a torque and/or a speed can be transmitted from the second variator 56 to the first and second transmission units 58, 212.

The second ring gear 802 of the second planetary transmission 800 is in engagement with the second planet 804 of the second planetary transmission 800, for example meshes with the second planet 804. The planet 804 of the second planetary transmission 800 is in engagement with the second sun 808 of the second planetary transmission 800, for example meshes with the second sun 808. The second planetary transmission 800, for example a component of the second planetary transmission 800, particularly for example the second planet carrier 806 of the second planetary transmission 800, is connected with the third spur gear stage 500. The fourth spur gear stage 502 is in engagement with the third spur gear stage 500, for example meshes with the third spur gear stage 500. Furthermore, the fourth spur gear stage 502 is connected with the fourth shifting element 234.

The fourth shifting element 234 is configured as the third output 210 and/or is the third output 210. Alternatively, or additionally, the fourth shifting element 234 can be connected with the third output 210. The fourth shifting element 234 can be connectable or connected with the layshaft 228. The second transmission unit 212, for example the fourth spur gear stage 502, can be connectable or connected with the layshaft 228 by way of or through or with the fourth shifting element 234.

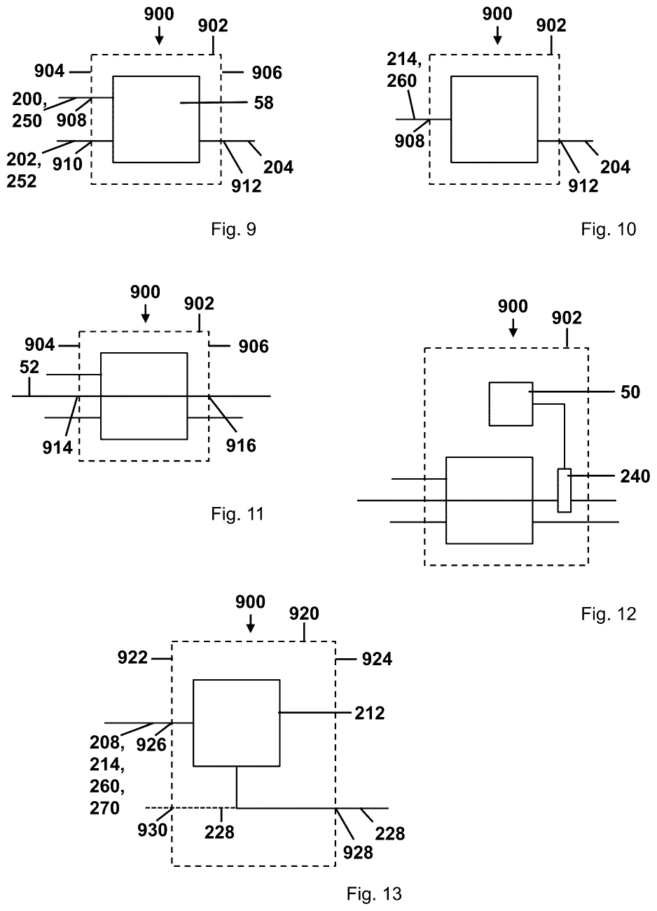

FIG. 9 shows a schematic representation of a first example embodiment of a transmission housing assembly 900 according to the disclosure. The transmission housing assembly 900 shown in FIG. 9 can comprise the drive device 20 shown in FIGS. 1 to 8 or components of the drive device 20 according to the disclosure, so only details and/or differences will be discussed below. The axle 100 or working machine 10 shown in FIGS. 1 to 5 can comprise the transmission housing assembly 900 shown in FIG. 9.

The housing wall of the first and/or second housing modules can have further or additional input and output openings, for example for connection to the second variator and/or the first variator and/or the layshaft.

The transmission housing assembly 900 comprises a first housing module 902 with the first transmission unit 58. Specifically, the first transmission unit 58 is arranged in the first housing module 902. The layshaft 228 (not shown) can also be arranged at least partially in the first housing module 902. The first housing module 902 has an input-side housing wall 904 and an output-side housing wall 906.

The input-side housing wall 904 of the first housing module 902 has a first and second input opening 908, 910. The output-side housing wall 906 of the first housing module 902 has a first output opening 912. The first input 200, for example the first drive element 250, is arranged in the first input opening 908. Specifically, the first input 200, for example the first drive element 250, can extend through the first input opening 908. As a result, the first input 200, for example the first drive element 250, can be connectable with the second variator 56. The second input 202, for example the second first drive element 252, is arranged in the second input opening 910. Specifically, the second input 202, for example the second drive element 252, can extend through the second input opening 910. As a result, the second input 202, for example the second drive element 252, can be connectable with the second variator 56.

The drive output 54, for example the drive output shaft or output shaft, is arranged in the first output opening 912 of the output-side housing wall 906 of the first housing module 902. Specifically, the drive output 54, for example the drive output shaft or output shaft, can extend at least partially through the first output opening 912. In addition, the layshaft 228 can be arranged in the first input opening 908 or the third input opening 926 of the input-side housing wall 904 of the first housing module 902. Specifically, the layshaft 228 can extend through the first input opening 908 or a third input opening 926.

FIG. 10 shows a schematic representation of a second example embodiment of a transmission housing assembly 900 according to the disclosure. The transmission housing assembly 900 shown in FIG. 10 can comprise the drive device 20 shown in FIGS. 1 to 8 or components of the drive device 20, for example the first and/or second transmission units 58, 212 and/or the first and second variators 50, 56 of the drive device 20 according to the disclosure. The transmission housing assembly 900 shown in FIG. 10 corresponds substantially to the transmission housing assembly 900 shown in FIG. 9, so only details and/or differences will be discussed below. The axle 100 or working machine 10 shown in FIGS. 1 to 5 can comprise the transmission housing assembly 900 shown in FIG. 10.

The input-side housing wall 904 of the first housing module 902 has only a first input opening 908. The common input 214, for example the common drive element 260, is arranged in the first input opening 908. Specifically, the common input 214, for example the common drive element 260, can extend through the first input opening 908. As a result, the common input 214, for example the common drive element 260, can be connectable with the second variator 56. However, the first and second inputs 200, 202, for example the first and second drive elements 250, 252, can also be arranged in the first input opening 908. Specifically, the first and second inputs 200, 202, for example the first and second drive elements 250, 252, can extend through the first input opening 908. As a result, the first and second inputs 200, 202, for example the first and second drive elements 250, 252, can be connectable with the second variator 56.

FIG. 11 shows a schematic representation of a third example embodiment of a transmission housing assembly 900 according to the disclosure. The transmission housing assembly 900 shown in FIG. 11 can comprise the drive device 20 shown in FIGS. 1 to 8 or components of the drive device 20, for example the first and/or second transmission units 58, 212 and/or the first and second variators 50, 56 of the drive device 20 according to the disclosure. The transmission housing assembly 900 shown in FIG. 11 corresponds substantially to the transmission housing assembly 900 shown in FIGS. 9 to 10, so only details and/or differences will be discussed below. The axle 100 or working machine 10 shown in FIGS. 1 to 5 can comprise the transmission housing assembly 900 shown in FIG. 11.

The input-side housing wall 904 and the output-side housing wall 906 of the first housing module 902 have a first and second conduit opening 914, 916, for example a central first and second conduit opening, for the drive 52, for example the input shaft. The drive 52 is arranged in the first and second conduit openings 914, 916. Specifically, the drive 52 can extend through the first and second conduit openings 914, 916. However, a further input-side housing wall and/or a further output-side housing wall of the first housing module 902 can have a first and second conduit opening 914, 916, for example a central first and second conduit opening, for the drive 52, for example the input shaft.

FIG. 12 shows a schematic representation of a fourth example embodiment of a transmission housing assembly 900 according to the disclosure. The transmission housing assembly 900 shown in FIG. 12 can comprise the drive device 20 shown in FIGS. 1 to 8 or components of the drive device 20, for example first and/or second transmission units 58, 212 and/or the first and second variators 50, 56 of the drive device 20 according to the disclosure. The transmission housing assembly 900 shown in FIG. 12 corresponds substantially to the transmission housing assembly 900 shown in FIGS. 9 to 11, so only details and/or differences will be discussed below. The axle 100 or working machine 10 shown in FIGS. 1 to 5 can comprise the transmission housing assembly 900 shown in FIG. 12. The first variator 50 and optionally the first transmission stage 240 are additionally arranged in the first housing module 902.

FIG. 13 shows a schematic representation of a fifth example embodiment of a transmission housing assembly 900 according to the disclosure. The transmission housing assembly 900 shown in FIG. 13 can comprise the drive device 20 shown in FIGS. 1 to 8 or components of the drive device 20, for example the first and/or second transmission units 58, 212 and/or the first and second variators 50, 56 of the drive device 20 according to the disclosure. The transmission housing assembly 900 shown in FIG. 13 corresponds substantially to the transmission housing assembly 900 shown in FIGS. 9 to 12, so only details and/or differences will be discussed below. The axle 100 or working machine 10 shown in FIGS. 1 to 5 can comprise the transmission housing assembly 900 shown in FIG. 13.

The transmission housing assembly 900 comprises a second housing module 920 with the second transmission unit 212. Specifically, the second transmission unit 212 is arranged in the second housing module 920. The second housing module 920 has an input-side housing wall 922 and an output-side housing wall 924. The input-side housing wall 922 of the second housing module 920 has at least one further input opening, for example a fourth input opening 926. The output-side housing wall 924 of the second housing module 920 has a second output opening 928.

The third input 208, for example the third drive element 270, is arranged in the further input opening, for example the fourth input opening 926. Specifically, the third input 208, for example the third drive element 270, can extend through the third input opening 926. As a result, the third input 208, for example the third drive element 270, can be connectable or connected with the second variator 56. Alternatively, the common input 214, for example the common drive element 260, can be arranged in the third input opening 926. Specifically, the common input 214, for example the common drive element 260, can extend through the third input opening 926. As a result, the common input 214, for example the common drive element 260, can be connectable with the second variator 56.

The layshaft 228 is arranged in the second output opening 928 of the output-side housing wall 924 of the second housing modules 920. Specifically, the layshaft 228 can extend through the second output opening 928. The layshaft 228 can optionally also be arranged in a fifth input opening 930 of the input-side housing wall 922 of the second housing module 920. Specifically, the layshaft 228 can extend through the fifth input opening 930.

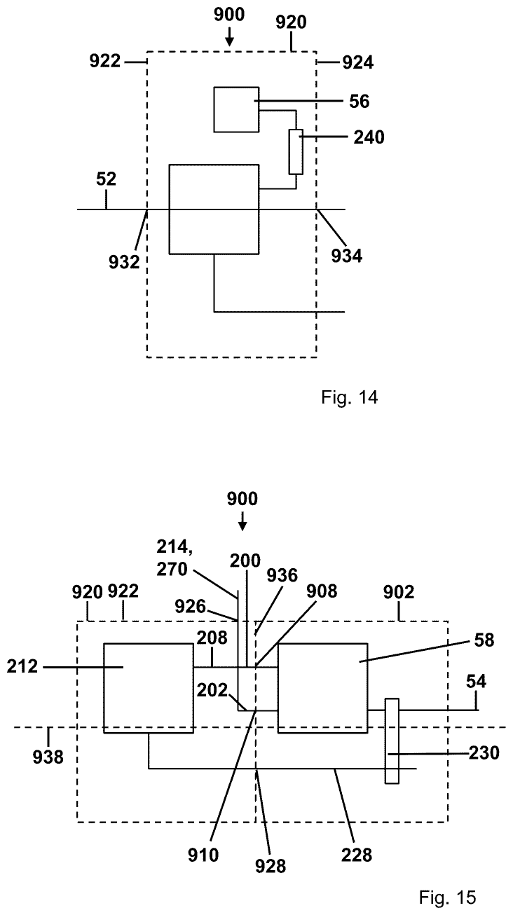

FIG. 14 shows a schematic representation of a sixth example embodiment of a transmission housing assembly 900 according to the disclosure. The transmission housing assembly 900 shown in FIG. 14 can comprise the drive device 20 shown in FIGS. 1 to 8 or components of the drive device 20, for example the first and/or second transmission units 58, 212 and/or the first and second variators 50, 56 of the drive device 20 according to the disclosure. The transmission housing assembly 900 shown in FIG. 14 corresponds substantially to the transmission housing assembly 900 shown in FIGS. 9 to 13, so only details and/or differences will be discussed below. The axle 100 or working machine 10 shown in FIGS. 1 to 5 can comprise the transmission housing assembly 900 shown in FIG. 14. The input-side housing wall 922 and the output-side housing wall 924 of the second housing module 920 have a third and fourth conduit opening 932, 934, for example a central third and fourth conduit opening, for the drive 52, for example the input shaft. The drive 52 is arranged in the third and fourth conduit openings 932, 934. Specifically, the drive 52 can extend through the third and fourth conduit openings 932, 934.

However, a further input-side housing wall and/or a further output-side housing wall of the second housing module 920 can have a third and fourth conduit opening 932, 934, for example a central third and fourth conduit opening, for the drive 52, for example the input shaft. Furthermore, the second variator 56 and/or the second transmission stage 242 can be arranged in the second housing module 920.

FIG. 15 shows a schematic representation of a seventh example embodiment of a transmission housing assembly 900 according to the disclosure. The transmission housing assembly 900 shown in FIG. 15 can comprise the drive device 20 shown in FIGS. 1 to 8 or components of the drive device 20, for example the first and/or second transmission units 58, 212 and/or the first and second variators 50, 56 of the drive device 20 according to the disclosure. The transmission housing assembly 900 shown in FIG. 15 corresponds substantially to the transmission housing assembly 900 shown in FIGS. 9 to 14, so only details and/or differences will be discussed below. The axle 100 or working machine 10 shown in FIGS. 1 to 5 can comprise the transmission housing assembly 900 shown in FIG. 15.

The input-side housing wall 904 of the first housing module 902 and the output-side housing wall 924 of the second housing module 920 are configured as a common housing wall 936 of the first and second housing modules 902, 920. The first housing module 902 can be connected with the second housing module 920, for example by way of or through the common housing wall 936. The common housing wall 936 of the first and second housing modules 902, 920 have the first and second input openings 908, 910 and the second output opening 928 as common openings.

The first and second inputs 200, 202, for example the first and second drive elements 250, 252, are arranged in the first and second input openings 908, 910 in the common housing wall 936. Specifically, the first and second inputs 200, 202, for example the first and second drive elements 250, 252, can extend through the first and second input openings 908, 910. The first and second and third inputs 200, 202, 208 are connected to the common input 214, for example the common drive element 260.

The common input 214, for example the common drive element 260, are arranged in the fourth input opening 926 in the input-side housing wall 922 of the second housing module 920. Specifically, the common input 214, for example the common drive element 260, can extend through the fourth input opening 926. The first and second housing modules 902, 920 are arranged along a longitudinal axis 938 of the transmission housing assembly 900.

The layshaft 228 is arranged in the first and second housing modules 902, 920. Moreover, the layshaft 228 is arranged in the second output opening 928 in the common housing wall 936. Specifically, the layshaft 228 can extend through the second output opening 928. Furthermore, the drive output 54 and the layshaft 228 are connectable or connected with one another through the third transmission stage 230.

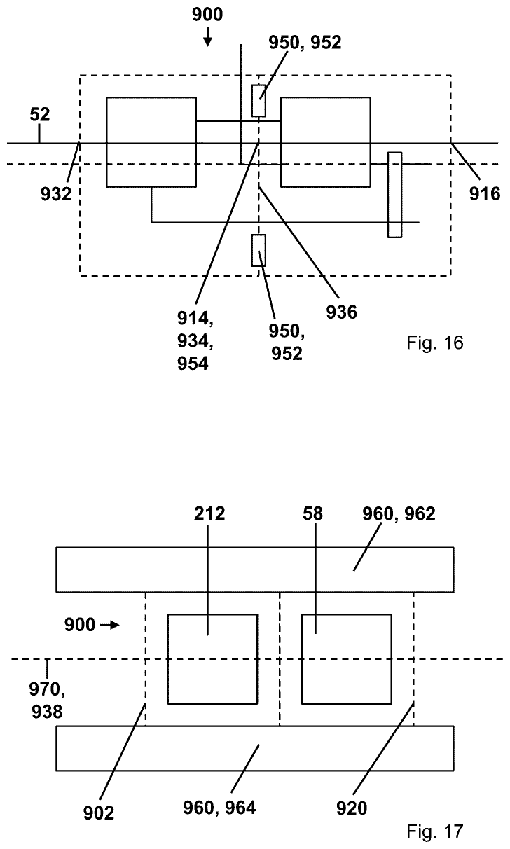

FIG. 16 shows a schematic representation of an eighth example embodiment of a transmission housing assembly 900 according to the disclosure. The transmission housing assembly 900 shown in FIG. 16 can comprise the drive device 20 shown in FIGS. 1 to 8 or components of the drive device 20, for example the first and/or second transmission units 58, 212 and/or the first and second variators 50, 56 of the drive device 20 according to the disclosure. The transmission housing assembly 900 shown in FIG. 16 corresponds substantially to the transmission housing assembly 900 shown in FIGS. 9 to 15, so only details and/or differences will be discussed below. The axle 100 or working machine 10 shown in FIGS. 1 to 5 can comprise the transmission housing assembly 900 shown in FIG. 16.

The first housing module 902 is connected with the second housing module 920, for example by way of or through the common housing wall 936. The first and second housing modules 902, 920 are connected with one another, for example fastened to one another, particularly for example releasably fastened to one another, with or through one or more fastening surfaces 950 and housing flanges 952. The first conduit opening 914 and the fourth conduit opening 934 are configured as a common conduit opening 954, for example a central common conduit opening, in the common housing wall 936.

The drive 52 is arranged in the first conduit opening 914, the common conduit opening 954 and the fourth conduit opening 934. Specifically, the drive 52 can extend through the first conduit opening 914 and the common conduit opening 954 and the fourth conduit opening 934.

FIG. 17 shows a detailed schematic representation of a further example embodiment of the working machine 10 according to the disclosure with a transmission housing assembly 900 according to the disclosure. The transmission housing assembly 900 shown in FIG. 17 can comprise the drive device 20 shown in FIGS. 1 to 8 or components of the drive device 20, for example the first and/or second transmission units 58, 212 and/or the first and second variators 50, 56 of the drive device 20 according to the disclosure. The transmission housing assembly 900 shown in FIG. 17 corresponds substantially to the transmission housing assembly 900 shown in FIGS. 9 to 16, so only details and/or differences will be discussed below. The axle 100 or working machine 10 shown in FIGS. 1 to 5 can comprise the transmission housing assembly 900 shown in FIG. 17.

FIG. 17 schematically shows two frame elements 960, for example a first and second frame element 962, 964, of the working machine 10. The transmission housing assembly 900, for example the first and/or second housing module 902, 920, are arranged at, for example between, the two frame elements 960, for example the first and second frame elements 962, 960. The frame elements 960, 962, 964 can be arranged at, for example between or directly adjacent to the first and second differentials 30, 32. The frame elements 960, 962, 964 can be connected with the first and/or second differential 30, 32. The motor 62 can be arranged at, for example on or between the two frame elements 960, for example the first and second frame elements 962, 964. The transmission housing assembly 900, for example the first and/or second housing modules 902, 920, are arranged along a longitudinal axis 970 of the working machine 10. The longitudinal axis 938 of the transmission housing assembly 900 and the longitudinal axis 970 of the working machine 10 can be identical or parallel.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A drive device, comprising:
a drive;
a drive output;
a first variator and a second variator; and
a first transmission unit having a first input, a second input, and a first output, the first variator connected with the drive, the second variator connected with the first input and the second input, the second variator being connectable with the drive output via the first transmission unit.

2. The drive device of claim 1, wherein the first transmission unit comprises a first spur gear stage, a second spur gear stage, a first planetary transmission, a first shifting element, and a second shifting element.

3. The drive device of claim 2, further comprising:
a second transmission unit including a third spur gear stage, a fourth spur gear stage, a second planetary transmission, a fourth shifting element, and a third input having a common input with the first and second transmission units.

4. The drive device of claim 3, wherein the first and second variators are configured as a hydrostat.

5. The drive device of claim 3, wherein the first variator is configured as a first electric motor and the second variator is configured as a second electric motor.

6. The drive device of claim 3, further comprising:
a motor being connectable with the first variator via the drive.

7. The drive device of claim 3, wherein the first and second transmission units include a conduit for the drive.

8. The drive device of claim 3, wherein the first variator and the motor are connectable with a first power output.

9. The drive device of claim 3, wherein the drive output and the first and second transmission units are connectable with a layshaft.

10. The drive device of claim 3, further comprising:
a control unit.

11. An axle comprising the drive device of claim 1.

12. A transmission housing assembly comprising the drive device of claim 1, wherein the transmission housing assembly comprises a first housing module with the first transmission unit, wherein the first housing module has an input-side housing wall and an output-side housing wall, and the input-side housing wall of the first housing module has at least a first input opening, and the output-side housing wall of the first housing module has a first output opening.

13. The transmission housing assembly of claim 12, further comprising:
a second housing module with the second transmission unit, wherein the second housing module has an input-side housing wall and an output-side housing wall, and the input-side housing wall of the second housing module has a fourth input opening, and the output-side housing wall of the second housing module has a second output opening.

14. The transmission housing assembly of claim 13, wherein the transmission housing assembly has a longitudinal axis, and the first and second housing modules are arranged along the longitudinal axis of the transmission housing assembly.

15. A working machine comprising the drive device of claim 1.

16. The working machine of claim 15, wherein the drive device is arranged at least partially on two frame elements.
